(19) United States
(12) Patent Application Publication
(10) Pub. No.: US 2026/0254386 A1
(43) Pub. Date: Aug. 27, 2026

(54) MOTOR CLOSED-LOOP DETECTION CIRCUIT AND METHOD

(71) Applicant: CRM ICBG (WUXI) CO., LTD., Wuxi (CN)

(72) Inventors: Chun HUA, Wuxi (CN); Xudong ZHAO, Wuxi (CN); Xinghua XIE, Wuxi (CN)

(73) Assignee: CRM ICBG (WUXI) CO., LTD., Wuxi (CN)

(21) Appl. No.: 18/994,075

(22) PCT Filed: Aug. 16, 2023
(86) PCT No.: PCT/CN2023/113290

§ 371 Date: Jan. 14, 2025

(30) Foreign Application Priority Data
Oct. 10, 2022 (CN) 202211236581.X

(51) Int. Cl. H02P 23/00; H02P 23/14

(52) U.S. Cl. CPC H02P 23/0004; H02P 23/14

(57) ABSTRACT

Motor closed-loop detection circuit and method are provided. The circuit includes: motor open-loop path for providing open-loop angle increment and calculating open-loop angle; motor prediction path for estimating motor's angle increment to obtain estimated angle increment and calculating estimated angle; and closed-loop detection module for outputting first closed-loop flag signal when the open-loop angle increment equals the estimated angle increment n consecutive times within an electrical cycle feeding back the first closed-loop flag signal to the motor open-loop path to adjust the open-loop angle increment, and outputting second closed-loop flag signal when the updated open-loop angle equals the estimated angle. The hardware circuit and existing motor paths reuse simplify the design, reduce costs, and minimize CPU load and power consumption. Shared components across modules from a computing library save costs. The method is simple, fast, and easy to implement. A same circuit achieves dual-level closed-loop functionality with minimal area consumption.

### FIELD OF THE INVENTION

The present invention relates to the field of motor control, and in particular, to a motor closed-loop detection circuit and a method.

### BACKGROUND OF THE INVENTION

Position sensorless motors are widely used in the field of motor control due to their low cost and high reliability. The position sensorless motors usually calculate their angle and speed of the position sensorless motor by using speed/angle estimation of a fundamental wave model of the motor or an observer-type algorithm. However, when the motor is stationary or in a low speed condition, a counter electromotive force of the position sensorless motor is small and a signal-to-noise ratio is low. Therefore, a correct angle and a correct speed cannot be estimated by using such an algorithm. A conventional startup method is divided into an initial rotor positioning stage, a speed open-loop and current closed-loop stage, and a speed closed-loop and current closed-loop stage. From speed open-loop control to speed closed-loop control, a difference between an electrical angle of the position sensorless motor and a given electrical angle that needs to be switched by from an accumulated open-loop angle to an estimated electrical angle is large. If switching is directly performed, a change angle jumps, which generates a current pulsation and a rotational speed jitter.

For the switching jitter problem mentioned above, a method is provided: After the motor reaches a current closed-loop state and a speed open-loop state, a current amplitude of a cross-axis is attenuated according to an exponential curve, so that a difference between the open-loop accumulation angle and the estimated position angle of the motor gradually decreases. A threshold range is set for the difference. When the difference between the two angles falls within the threshold range, it is determined that the difference between the two angles is close to zero, to determine that a rotor is in a load smooth state, and a closed-loop operation stage is switched to. However, the balance of an operating state of a system is broken at a switching moment, and the motor may be in a risk of out-of-step. In addition, in the method, a long-time current regulation process is required, to keep the motor operating in a “steady state”. Moreover, the regulation process is strongly dependent on a CPU, which occupies more CPU resources, and has high requirements on an operating frequency of the CPU. Therefore, how to propose a new motor closed-loop detection method, to avoid a risk of motor out-of-step, improve detection efficiency, and not occupy CPU resources has become one of the problems urgently to be resolved by a person skilled in the art.

It should be noted that the foregoing descriptions of the technical background are merely described for facilitating a clear and complete description of the technical solutions of the present invention and facilitating understanding by a person skilled in the art. The foregoing technical solutions are not considered as well-known to a person skilled in the art only because these solutions are described in the background part of the present invention.

### SUMMARY OF THE INVENTION

The present invention provides a motor closed-loop detection circuit and a method. The motor closed-loop detection circuit includes at least:
a motor open-loop path, a motor prediction path, and a closed-loop detection module.

The motor open-loop path is configured to provide an open-loop angle increment and calculate an open-loop angle based on the open-loop angle increment.

The motor prediction path is configured to estimate an angle increment of a motor based on a sampling signal of the motor to obtain an estimated angle increment, and calculate an estimated angle based on the estimated angle increment.

The closed-loop detection module is connected to output terminals of the motor open-loop path and the motor prediction path. A first closed-loop flag signal is output when the open-loop angle increment is equal to the estimated angle increment n consecutive times within an electrical cycle range, and the first closed-loop flag signal is fed back to the motor open-loop path to adjust the open-loop angle increment. Comparing the updated open-loop angle with the estimated angle, a second closed-loop flag signal is output when the open-loop angle is equal to the estimated angle to complete closed-loop detection and enter closed-loop control. n is a natural number greater than or equal to 1.

Optionally, the motor open-loop path includes an open-loop angle increment generation module and an open-loop angle calculation module. The open-loop angle increment generation module is configured to provide the open-loop angle increment. The open-loop angle calculation module is connected to an output terminal of the open-loop angle increment generation module, and is configured to calculate an open-loop angle of a current cycle based on an open-loop angle of a previous cycle and an open-loop angle increment of the current cycle.

More optionally, the open-loop angle increment generation module includes an increment generation unit and a multiplier. The increment generation unit is configured to output the open-loop angle increment. The multiplier is configured to receive an output signal of the increment generation unit, and perform a multiplication operation between the open-loop angle increment and a preset multiple when the first closed-loop flag signal is valid, to adjust the open-loop angle increment.

More optionally, the increment generation unit includes a first adder. The first adder is configured to perform an addition operation between an open-loop angle increment of the previous cycle and an angle addition increment of the current cycle, to obtain the open-loop angle increment of the current cycle.

More optionally, the open-loop angle calculation module includes a second adder. The second adder is configured to perform an addition operation between an open-loop angle of the previous cycle and the open-loop angle increment of the current cycle.

Optionally, the motor prediction path includes a sliding mode observer, a phase-locked loop, and an angle estimation module. The sliding mode observer is configured to observe motor energy based on the sampling signal. The phase-locked loop is connected to an output terminal of the sliding mode observer, and is configured to extract the estimated angle increment based on the motor energy observed by the sliding mode observer and sine and cosine feedback signals of an estimated angle of the previous cycle. The angle estimation module is connected to an output terminal of the phase-locked loop, and is configured to calculate an estimated angle of the current cycle based on the estimated angle of the previous cycle and an estimated angle increment of the current cycle, and generate sine and cosine feedback signals of the estimated angle.

More optionally, the angle estimation module includes a third adder and a sine and cosine calculation unit. The third adder is configured to perform an addition operation between the estimated angle of the previous cycle and the estimated angle increment of the current cycle. The sine and cosine calculation unit is configured to receive an output signal of the third adder, and perform sine and cosine calculations respectively on the estimated angle output by the third adder.

Optionally, the closed-loop detection module includes a comparison unit and a logic unit. An input terminal of the comparison unit is connected to the output terminals of the motor open-loop path and the motor prediction path. The comparison unit is configured to compare high-k bits of the open-loop angle increment and high-k bits of the estimated angle increment in a one-to-one correspondence, and compare high-k bits of the open-loop angle and high-k bits of the estimated angle in a one-to-one correspondence. The logic unit is connected to an output terminal of the comparison unit. A first closed-loop flag signal is output when corresponding bits of the open-loop angle increment and the estimated angle increment are all equal n consecutive times within an electrical cycle range. A second closed-loop flag signal is output when corresponding bits of the open-loop angle and the estimated angle are all equal. k is a natural number greater than or equal to 1.

More optionally, the motor closed-loop detection circuit further includes a calculation module. The calculation module is connected to the motor open-loop path, the motor prediction path, and the closed-loop detection module, and calculations in the motor open-loop path, the motor prediction path, and the closed-loop detection module are completed by reusing a calculation unit in the calculation module.

A motor closed-loop detection method is further provided. The motor closed-loop detection method includes at least:
separately acquiring an open-loop angle increment and an estimated angle increment, comparing the open-loop angle increment with the estimated angle increment, and generating a first closed-loop flag signal when the open-loop angle increment is equal to the estimated angle increment n consecutive times within an electrical cycle range. n is a natural number greater than or equal to 1; and
adjusting the open-loop angle increment under triggering of the first closed-loop flag signal, and generating a second closed-loop flag signal when an open-loop angle is equal to an estimated angle, where the second closed-loop flag signal is a signal that allows a motor to switch from an open loop to a closed loop.

Optionally, a method for comparing the open-loop angle increment with the estimated angle increment includes: comparing high-k bits of the open-loop angle increment with high-k bits of the estimated angle increment in a one-to-one correspondence n consecutive times within an electrical cycle range. A method for comparing the open-loop angle with the estimated angle includes: comparing high-k bits of the open-loop angle with high-k bits of the estimated angle in a one-to-one correspondence. k is a natural number greater than or equal to 1.

More optionally, a method for adjusting the open-loop angle increment includes: increasing a multiple of an original open-loop angle increment, to satisfy the following relational expression:

$${Δθ}^{′} = X * Δθ ,$$

Where Δθ′ is an updated open-loop angle increment, Δθ is the original open-loop angle increment, and X is a preset multiple greater than 1.

As described above, the motor closed-loop detection circuit and method according to the present invention have the following beneficial effects:
1. The motor closed-loop detection circuit and the method of the present invention adopt a hardware circuit and reuse the existing motor open-loop path and motor prediction path, so that the closed-loop detection function can be implemented only by reusing one multiplier, one adder, and one group of comparators, resulting in a simple structure and low costs.
2. In the motor closed-loop detection circuit and the method consistent with the present invention, devices in a computing unit library are reused for calculations of the modules, so that costs are further reduced.
3. In the motor closed-loop detection circuit and the method consistent with the present invention, closed-loop detection is implemented by comparing the open-loop angle increment and the open-loop angle with the corresponding estimated values. The method is simple and easy to implement, and a closed-loop speed is fast.
4. In the motor closed-loop detection circuit and the method consistent with the present invention, a same closed-loop detection circuit is used for angle increment closed-loop detection and angle cross closed-loop switching detection, so that a two-stage closed-loop function is implemented, and area consumption is extremely small.
5. In the motor prediction path in the motor closed-loop detection circuit and the method consistent with the present invention, the motor prediction path is implemented by using a hardware circuit, which does not occupy CPU resources, so that the motor has low operating power consumption.

### BRIEF DESCRIPTION OF DRAWINGS

FIG. 1 is a schematic structural diagram of a motor closed-loop detection circuit according to one embodiment of the present invention.

FIG. 2 is a schematic structural diagram of an open-loop angle increment generation module according to the present invention.

FIG. 3 is a schematic structural diagram of a phase-locked loop according to the present invention.

FIG. 4 is a schematic structural diagram of a closed-loop detection module according to the present invention.

FIG. 5 is a schematic structural diagram of a motor closed-loop detection circuit according to another embodiment of the present invention.

FIG. 6 is a schematic flowchart of a motor closed-loop detection method according to the present invention.

FIG. 7 is a schematic diagram of a principle of a motor closed-loop detection method according to the present invention.

### REFERENCE NUMERALS

1 Motor open-loop path
11 Open-loop angle increment generation module
111 Increment generation unit
112 Multiplier
12 Open-loop angle calculation module
2 Motor prediction path
21 Sliding mode observer
22 Phase-locked loop
221 First multiplication unit
222 Second multiplication unit
223 Fourth adder
224 PI error calculation unit
225 Fifth adder
226 First filter
227 Second filter
23 Angle estimation module
3 Closed-loop detection module
31 Comparison unit
32 Logic unit
321 AND gate
322 Accumulation counter
4 Calculation module
41 Adder
42 Multiplier
43 Sine and cosine calculation unit
44 Comparator group

### DETAILED DESCRIPTION

The specific embodiments are described below to illustrate the implementation of the present invention, and those skilled in the art can easily understand other advantages and effects of the present invention from the content disclosed in this specification. The present invention can also be implemented or applied in other specific embodiments. The details provided in this description can be modified or altered in various ways based on different perspectives and applications without departing from the spirit of the present invention.

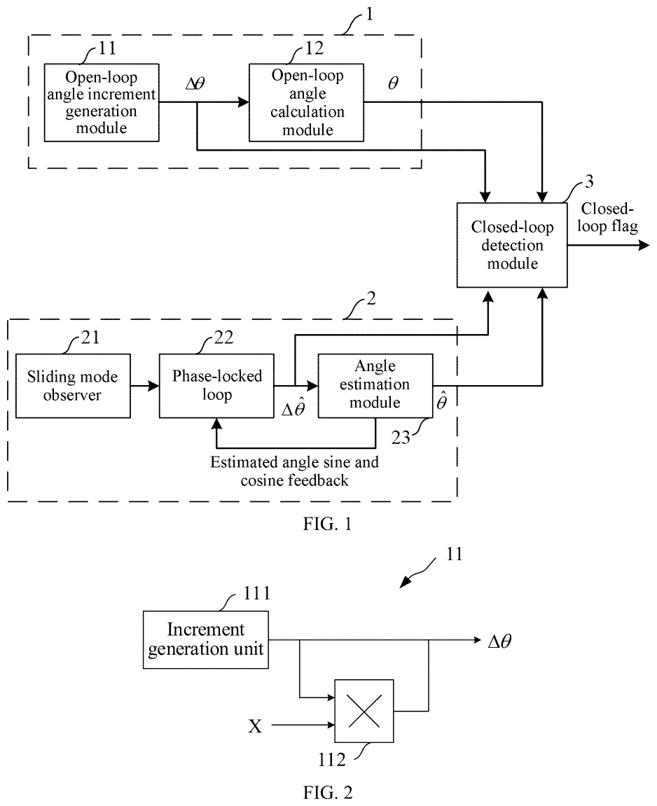

Refer to FIG. 1 to FIG. 7. It should be noted that, the drawings provided in this embodiment only exemplify the basic idea of the present invention, and only the components related to the present invention rather than the number, shape and size of the components in actual implementation are shown in the drawings, and the types, the number and the proportion of the components in the actual implementation may be randomly changed, and the layout type of the components may also be more complex.

### Embodiment 1

As shown in FIG. 1, a motor closed-loop detection circuit is provided. The motor closed-loop detection circuit includes:
a motor open-loop path 1, a motor prediction path 2, and a closed-loop detection module 3.

As shown in FIG. 1, the motor open-loop path 1 provides an open-loop angle increment Δθ and calculates an open-loop angle θ based on the open-loop angle increment Δθ.

Specifically, in this embodiment, the motor open-loop path 1 includes an open-loop angle increment generation module 11 and an open-loop angle calculation module 12. The open-loop angle increment generation module 11 provides the open-loop angle increment Δθ. The open-loop angle calculation module 12 is connected to an output terminal of the open-loop angle increment generation module 11, and is configured to calculate an open-loop angle θₙ of a current cycle based on an open-loop angle θₙ₋₁ of a previous cycle and an open-loop angle increment Δθₙ of the current cycle.

More specifically, as shown in FIG. 2, in this embodiment, the open-loop angle increment generation module 11 includes an increment generation unit 111 and a multiplier 112. The increment generation unit 111 is configured to output the open-loop angle increment Δθ, and the open-loop angle increment Δθ may be positive or negative. In an example, the open-loop angle increment Δθ is a constant value set as required. In another example, if the open-loop angle increment Δθ gradually increases or decreases as time changes, the increment generation unit 111 includes a first adder. The first adder is configured to perform an addition operation between an open-loop angle increment of the previous cycle Δθₙ₋₁ and an angle addition increment Δ²θ of the current cycle (the angle addition increment represents a speed at which the angle increment increases, that is, an acceleration at which the angle increment increases, Δ²θ is an identifier of the acceleration, and does not represent that it has a square relationship with Δθ), to obtain the open-loop angle increment Δθₙ of the current cycle, that is, Δθₙ=Δθₙ₋₁+Δ²θ. The angle addition increment Δ²θ may be a constant value or may gradually increases or decreases as time changes, and the angle addition increment Δ²θ may be positive or negative. When the angle addition increment Δ²θ is a positive value, the open-loop angle increment Δθ increases, and when the angle addition increment Δ²θ is a negative value, the open-loop angle increment Δθ decreases. The multiplier 112 is configured to receive an output signal of the increment generation unit 111, and perform a multiplication operation between the open-loop angle increment Δθ and a preset multiple X when the first closed-loop flag signal CL1 is valid, to adjust the open-loop angle increment Δθ.

More specifically, for example, the open-loop angle calculation module 12 includes a second adder. The second adder is configured to perform an addition operation between the open-loop angle θₙ₋₁ of the previous cycle and the open-loop angle increment Δθₙ of the current cycle, that is, θₙ=θₙ₋₁+Δθₙ.

It should be noted that, the open-loop angle increment generation module 11 and the open-loop angle calculation module 12 may store data of the previous cycle and preset data by setting a register, which will not be repeated here.

As shown in FIG. 1, the motor prediction path 2 is configured to estimate an angle increment of a motor based on a sampling signal of the motor to obtain an estimated angle increment Δ\hat{θ}, and calculate an estimated angle \hat{θ} based on the estimated angle increment Δ\hat{θ}.

Specifically, in this embodiment, the motor prediction path 2 includes a sliding mode observer (SMO) 21, a phase-locked loop 22, and an angle estimation module 23. The sliding mode observer 21 is configured to observe motor energy based on the sampling signal. The phase-locked loop 22 is connected to an output terminal of the sliding mode observer 21, and is configured to extract the estimated angle increment Δ\hat{θ} based on the motor energy observed by the sliding mode observer 21, as well as sine and cosine feedback signals of an estimated angle of the previous cycle. The angle estimation module 23 is connected to an output terminal of the phase-locked loop 22, and is configured to estimate an estimated angle \hat{θ}ₙ of the current cycle based on the estimated angle \hat{θ}ₙ₋₁ of the previous cycle and an estimated angle increment Δ\hat{θ}n of a current cycle, and generate a sine feedback signal sin(\hat{θ}) and a cosine feedback signal cos(\hat{θ}) of the estimated angle.

More specifically, the sliding mode observer 21 acquires current and voltage signals obtained after coordinate conversion of the sampling signal, to observe the motor energy. For example, the sampling signal is a three-phase current sampling signal of the motor (only two phases of current actually need to be sampled at a minimum, and the third-phase current may be calculated). A current of a coordinate system α-β is obtained by performing a Clark transformation on the sampling signal. Then, a current and a voltage of a coordinate system d-q are obtained by performing a Park transformation on the current of the coordinate system α-β. Finally, a voltage of the coordinate system α-β is obtained by performing an inverse Park transformation on the voltage of the coordinate system d-q. The sliding mode observer 21 is configured to observe and estimate motor energies ê_{α} and ê_{β} in the coordinate system α-based on the current and the voltage of the coordinate system α-β. The motor energies include information about a motor angle and an angular velocity. The sliding mode observer 21 is a hardware circuit, and any circuit structure that can observe the motor energy is applicable to the present invention. For example, the sliding mode observer 21 is a customized microprocessor (MPU), an application-specific integrated circuit (ASIC), a field-programmable gate array (FPGA), or the like that can perform a sliding mode observation function.

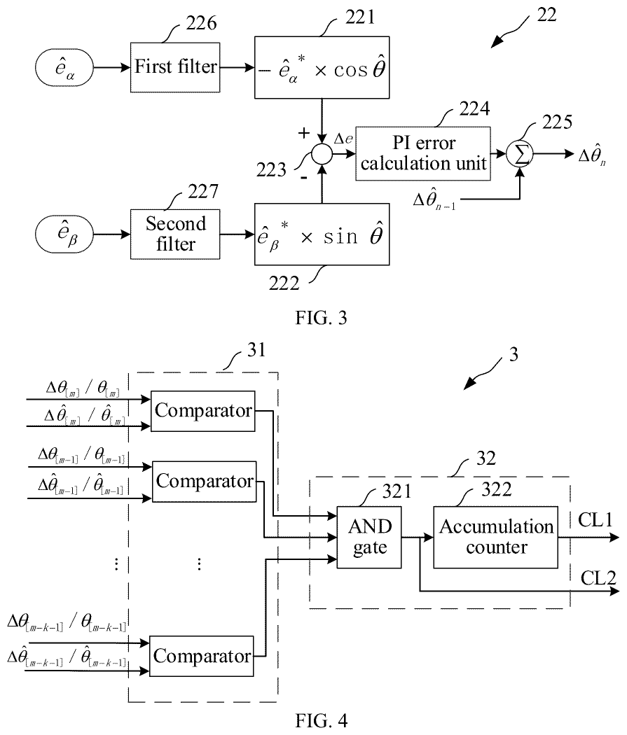

More specifically, the phase-locked loop 22 is configured to extract a motor angle increment. As shown in FIG. 3, for example, the phase-locked loop 22 includes a first multiplication unit 221, a second multiplication unit 222, a fourth adder 223, a PI error calculation unit 224 (for example, the PI error calculation unit 224 is a proportional integrator with upper limit control), and a fifth adder 225. The first multiplier 221 is configured to invert the motor energy ê_{α} and then multiply the inverted motor energy by the cosine feedback signal cos(\hat{θ}) of the estimated angle. The second multiplier 222 is configured to multiply the motor energy ê_{β} by the sine feedback signal sin(θ) of the estimated angle. The fourth adder 223 is configured to add output signals of the first multiplication unit 221 and the second multiplication unit 222 to obtain an estimated energy error Δe. The PI error calculation unit 224 is configured to extract an error of the estimated angle increment based on the estimated energy error Δe. The fifth adder 225 is configured to add the error of the estimated angle increment to a previous estimated angle increment Δ\hat{θ}ₙ₋₁, to obtain a current estimated angle increment Δ\hat{θ}ₙ. In another implementation of the present invention, the phase-locked loop 22 further includes a first filter 226 and a second filter 227. The first filter 226 and the second filter 227 are respectively connected to input terminals of the first multiplication unit 221 and the second multiplication unit 222 and are configured to perform first-order digital low-pass filtering on inputted motor energy to obtain filtered values ê_{α}* and ê_{β}* of the motor energy. The phase-locked loop 22 is a hardware circuit, and any circuit structure that can obtain the estimated angle increment is applicable to the present invention, which is not limited to this embodiment.

More specifically, the angle estimation module 23 includes a third adder and a sine and cosine calculation unit. The third adder is configured to perform an addition operation between the estimated angle \hat{θ}ₙ₋₁ of the previous cycle and the estimated angle increment Δ\hat{θ}ₙ of the current cycle, that is, \hat{θ}ₙ=\hat{θ}ₙ₋₁+Δ\hat{θ}ₙ. The sine and cosine calculation unit is configured to receive an output signal of the third adder, and perform sine and cosine calculations respectively on the estimated angle output by the third adder, to obtain the sine feedback signal sin(\hat{θ}) and the cosine feedback signal cos(\hat{θ}) of the estimated angle. The angle estimation module 23 is implemented by using the hardware circuit. The sine and cosine calculation unit may include an analog circuit, such as a phase-locked loop (PLL) or a direct digital synthesizer (DDS), or a digital circuit, such as a microcontroller or a digital signal processor (DSP) running a proper algorithm.

It should be noted that, in this embodiment, the motor open-loop path 1 is an original path in a motor control system, and is configured to implement motor startup. The motor prediction path 2 is an original path in the motor control system, and is configured to implement motor closed-loop control. In the present invention. In the present invention, closed-loop detection is implemented based on output signals of the motor open-loop path 1 and the motor prediction path 2. By reusing original components, the structure is greatly simplified and costs are reduced.

As shown in FIG. 1, the closed-loop detection module 3 is connected to output terminals of the motor open-loop path 1 and the motor prediction path 2. A first closed-loop flag signal CL1 is output when the open-loop angle increment Δθ is equal to the estimated angle increment Δ\hat{θ} n consecutive times within an electrical cycle range, and the first closed-loop flag signal CL1 is fed back to the motor open-loop path 1 to adjust the open-loop angle increment Δθ. Comparing the updated open-loop angle θ with the estimated angle \hat{θ}, a second closed-loop flag signal CL2 is output when the open-loop angle θ is equal to the estimated angle \hat{θ} to complete closed-loop detection and enter closed-loop control. n is a natural number greater than or equal to 1, for example, n=7.

Specifically, as shown in FIG. 4, in this embodiment, the closed-loop detection module 3 includes a comparison unit 31 and a logic unit 32. An input terminal of the comparison unit 31 is connected to output terminals of the motor open-loop path 1 and the motor prediction path 2, and the comparison unit 31 is configured to compare the open-loop angle increment and the open-loop angle with corresponding estimated values respectively. The logic unit 32 is connected to the output terminal of the comparison unit 31. The first closed-loop flag signal CL1 is output when corresponding bits of the open-loop angle increment and the estimated angle increment are all equal n consecutive times within an electrical cycle range, and the second closed-loop flag signal CL2 is output when corresponding bits of the open-loop angle increment and the estimated angle are all equal.

More specifically, for example, the comparison unit 31 includes k comparators that respectively compare high-k bits of the open-loop angle increment with high-k bits of the estimated angle increment in a one-to-one correspondence (that is, compare the first k high bits of values of the two increments), and compare high-k bits of the open-loop angle with high-k bits of the estimated angle in a one-to-one correspondence. Each angle increment and angle is m bits of data, and k is a natural number greater than or equal to 1 (and less than or equal to m). When k is greater, accuracy of closed-loop detection is higher, but difficulty of closed-loop is higher. A value of k may be balanced between the accuracy and difficulty of the closed-loop according to specific needs. In this example, if m is greater than 9, k is selected to be a value less than or equal to 9 (when k is 9, accuracy is approximately 1° and a closed-loop can be implemented). If m is less than or equal to 9, k is selected to be less than or equal to m. The comparison unit 31 is time-division multiplexed, and is configured to separately perform angle increment closed-loop detection and angle cross closed-loop switching detection.

More specifically, for example, the logic unit 32 includes an AND gate 321 and an accumulation counter 322. The AND gate 321 is configured to output a high level when comparison results of the corresponding bits of the open-loop angle increment and the estimated angle increment are all high levels. The accumulation counter 322 is configured to accumulate the high level output by the AND gate 321. When a quantity of times of consecutive accumulation of the high level output by the AND gate 321 reaches n times, the first closed-loop flag signal CL1 is valid. When comparison results of the corresponding bits of the open-loop angle and the estimated angle are all high levels, the AND gate 321 outputs the high level, and the second closed-loop flag signal CL2 is valid. During actual use, the logic unit 32 may adopt any logic circuit, as long as the logic of the present invention can be implemented, which is not limited in this embodiment. The first closed-loop flag signal CL1 output by the logic unit 32 is fed back to the motor open-loop path 1 to trigger the adjustment of the open-loop angle increment Δθ, so that the open-loop angle θ intersects with the estimated angle \hat{θ}.

The motor closed-loop detection circuit of the present invention performs closed-loop detection by comparing the open-loop angle increment, open-loop angle, and corresponding estimated values. The method is simple, easy to implement, and achieves fast closed-loop detection. In addition, a same closed-loop detection circuit is used for the angle increment closed-loop detection and the angle cross closed-loop switching detection, thereby realizing a two-stage closed-loop function with minimal area consumption.

### Embodiment 2

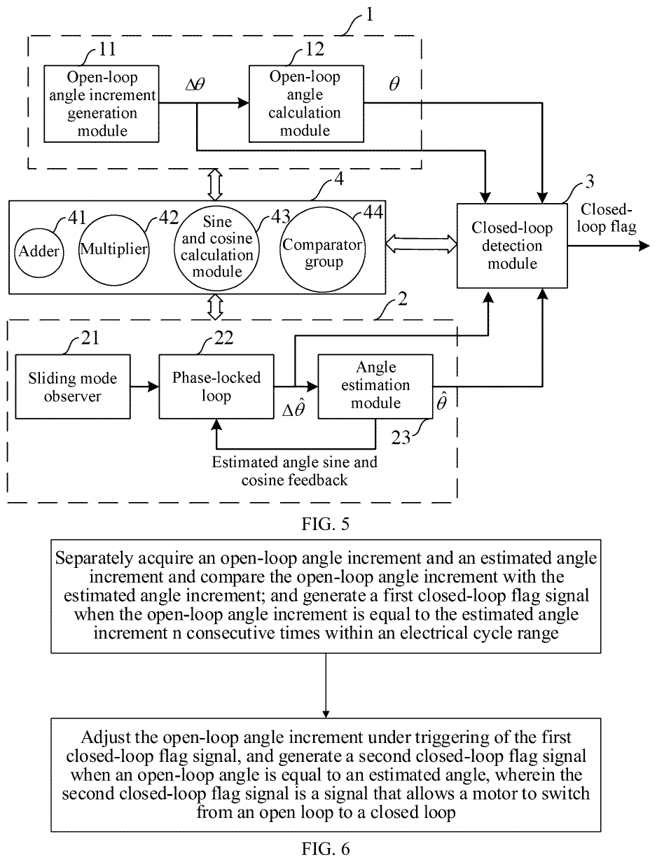

As shown in FIG. 5, a motor closed-loop detection circuit is provided. Different from Embodiment 1, in this embodiment, the calculations and comparisons of each module are implemented by reusing a computing unit library.

Specifically, as shown in FIG. 5, the motor closed-loop detection circuit includes a calculation module 4. The calculation module 4 is connected to the motor open-loop path 1, the motor prediction path 2, and the closed-loop detection module 3. The calculation module 4 includes a plurality of calculation units, including but not limited to, an adder 41, a multiplier 42, a sine and cosine calculation unit 43, and a comparator group 45. Any calculation unit required by the motor closed-loop detection circuit may be arranged in the calculation module 4. There is no need to provide an operation and/or comparison device in the motor open-loop path 1, the motor prediction path 2, and the closed-loop detection module 3. A signal to be calculated and/or compared is inputted into the calculation module 4 for processing, and is then fed back to a corresponding path or module after the processing is completed. Therefore, the calculation units in the paths and the modules can be time-division multiplexed, thereby saving area and costs.

Other structures and principles are the same as those in Embodiment 1, and details are not described herein again.

### Embodiment 3

As shown in FIG. 6, a motor closed-loop detection method is provided. In this example, the motor closed-loop detection method is implemented based on the motor closed-loop detection circuit in Embodiment 1 or Embodiment 2, and any hardware or software that can implement the method is applicable during actual use. The motor closed-loop detection method includes:
1) separately acquiring an open-loop angle increment Δθ and an estimated angle increment Δ\hat{θ}, comparing the open-loop angle increment Δθ and the estimated angle increment Δ\hat{θ}, and generating a first closed-loop flag signal CL1 when the open-loop angle increment Δθ is equal to the estimated angle increment Δ\hat{θ}n consecutive times within an electrical cycle range; and

Specifically, the open-loop angle increment Δθ is acquired. The open-loop angle increment Δθ may be a preset constant value, or may be a value that changes with time. In this example, the open-loop angle increment Δθ gradually increases as time changes, and satisfies the following: Δθₙ=Δθₙ₋₁+Δ²θ, where the angle addition increment Δ²θ may be set to a constant value or a variable value as required.

Specifically, in this embodiment, a method for acquiring the estimated angle increment Δ\hat{θ} includes: performing coordinate conversion on a sampling signal of a motor, to obtain a current and a voltage of a coordinate system α-β through Clark transformation, Park transformation, and inverse Park transformation, observing motor energies ê_{α} and ê_{β} in the coordinate system α-β, and obtaining the estimated angle increment Δ\hat{θ} based on the motor energies ê_{α}, ê_{β}, and a sine feedback signal sin(\hat{θ}) and a cosine feedback signal cos(\hat{θ}) of the estimated angle through a phase-locked loop. During actual use, any method that can estimate the angle increment of the motor is applicable to the present invention, which is not limited to this embodiment.

Specifically, the open-loop angle increment Δθ is compared with the estimated angle increment Δ\hat{θ}. In this embodiment, the open-loop angle increment Δθ and the estimated angle increment Δ\hat{θ} are both m-bit data signals. The high-k bits of the open-loop angle increment Δθ are compared with the high-k bits of the estimated angle increment Δ\hat{θ} in a one-to-one correspondence, and comparison results are output. k is a natural number greater than or equal to 1 and less than m. For example, k is less than or equal to 9. In other words, a minimum deviation value of an angle or an angle increment between an open-loop value and an estimated value may be set to (360/512)°. When the corresponding bits (high-k bits) of the open-loop angle increment Δθ and the estimated angle increment Δ\hat{θ} are equal n consecutive times within an electrical cycle range, it represents that the open-loop angle increment Δθ is equal to the estimated angle increment Δ\hat{θ}, and the first closed-loop flag signal CL1 is generated. n is a natural number greater than or equal to 1, for example, n is 7.

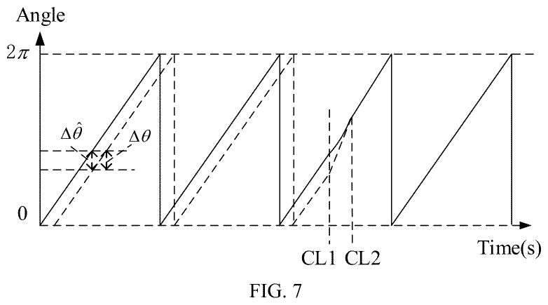

Specifically, as shown in FIG. 7, when the open-loop angle increment Δθ is equal to the estimated angle increment Δ\hat{θ} n consecutive times within an electrical cycle range, the first closed-loop flag signal CL1 is generated. In this case, an open-loop operation speed of the motor is the same as an estimated speed of an observation path of the motor, and change curves of an open-loop angle (dashed line) and an estimated angle (solid line) are parallel.
2) adjusting the open-loop angle increment Δθ under the triggering of the first closed-loop flag signal CL1, generating a second closed-loop flag signal CL2 when the open-loop angle θ is equal to the estimated angle \hat{θ}, where the second closed-loop flag signal CL2 is a signal that allows the motor to switch from an open loop to a closed loop.

Specifically, when the first closed-loop flag signal CL1 is valid, the open-loop angle increment Δθ is adjusted. For example, a method for adjusting the open-loop angle increment Δθ includes: increasing a multiple of an original open-loop angle increment Δθ, to satisfy the following relational expression:

$${Δθ}^{′} = X * Δθ ,$$

where Δθ′ is an updated open-loop angle increment, and Δθ is the original open-loop angle increment. X is a preset multiple. In this example, X is greater than 1. During actual use, X may also be set to be less than 1, so that the open-loop angle θ intersects with the estimated angle \hat{θ}, as shown in FIG. 7.

Specifically, after the first closed-loop flag signal CL1 is valid, the open-loop angle θ is compared with the estimated angle \hat{θ}. In this embodiment, the open-loop angle θ and the estimated angle \hat{θ} are both m-bit data signals. The high-k bits of the open-loop angle θ are compared with the high-k bits of the estimated angle \hat{θ} in a one-to-one correspondence, and a comparison result is output, where k is a natural number greater than or equal to 1 and less than m. For example, k is less than or equal to 9. When the corresponding bits (high-k bits) of the open-loop angle θ and the estimated angle \hat{θ} are equal, it represents that the open-loop angle θ is equal to the estimated angle \hat{θ}, and the second closed-loop flag signal CL2 is generated. After the second closed-loop flag signal CL2 is valid, the motor may be controlled to enter a closed-loop control stage.

The motor closed-loop detection method of the present invention adopts a hierarchical closed-loop mode, which has high reliability and fast closed-loop speed.

In summary, the present invention provides a motor closed-loop detection circuit and method. The motor closed-loop detection circuit includes: a motor open-loop path, a motor prediction path, and a closed-loop detection module. The motor open-loop path is configured to provide an open-loop angle increment, and calculate an open-loop angle based on the open-loop angle increment. The motor prediction path is configured to estimate an angle increment of a motor based on a sampling signal of a motor to obtain an estimated angle increment, and calculate an estimated angle based on the estimated angle increment. The closed-loop detection module is connected to output terminals of the motor open-loop path and the motor prediction path. The closed-loop detection module is connected to output terminals of the motor open-loop path and the motor prediction path. A first closed-loop flag signal is output when the open-loop angle increment is equal to the estimated angle increment n consecutive times within an electrical cycle range, and the first closed-loop flag signal is fed back to the motor open-loop path to adjust the open-loop angle increment. Comparing the updated open-loop angle with the estimated angle, a second closed-loop flag signal is output when the open-loop angle is equal to the estimated angle to complete closed-loop detection and enter closed-loop control. The motor closed-loop detection circuit and method of the present invention adopt a hardware circuit and reuse the existing motor open-loop path and motor prediction path, so that the closed-loop detection function can be implemented only by adding simple calculations and comparison devices, resulting in a simple structure and low costs. Devices in a computing unit library are reused for calculations of modules, so that costs are further reduced. The closed-loop detection is implemented by comparing the open-loop angle increment and the open-loop angle with the corresponding estimated values. The method is simple and easy to implement, and the closed-loop speed is fast. A same closed-loop detection circuit is used for an angle increment closed-loop detection and an angle cross closed-loop switching detection, so that a two-stage closed-loop function is implemented, and area consumption is extremely small. The motor prediction path is implemented by using a hardware circuit, which does not occupy CPU resources, so that the motor has low operating power consumption. Therefore, the present invention effectively addresses the limitations of existing technologies, making it highly valuable for industrial applications.

The embodiments described above serve merely as illustrative examples of the principles and effects of the present invention, and are not intended to serve as limitations on the present invention. Persons skilled in the art may modify or alter these embodiments without departing from the spirit and scope of the present invention. Accordingly, all equivalent modifications or alterations accomplished by persons having ordinary knowledge in the art without departing from the spirit and technical ideas disclosed herein shall still be covered by the claims of the present invention.

1. A motor closed-loop detection circuit, wherein the motor closed-loop detection circuit comprises at least:
a motor open-loop path, a motor prediction path, and a closed-loop detection module, wherein
the motor open-loop path is configured to provide an open-loop angle increment, and calculate an open-loop angle based on the open-loop angle increment;
the motor prediction path is configured to estimate an angle increment of a motor based on a sampling signal of the motor to obtain an estimated angle increment, and calculate an estimated angle based on the estimated angle increment; and
the closed-loop detection module is connected to output terminals of the motor open-loop path and the motor prediction path, wherein a first closed-loop flag signal is output when the open-loop angle increment is equal to the estimated angle increment n consecutive times within an electrical cycle range, and the first closed-loop flag signal is fed back to the motor open-loop path to adjust the open-loop angle increment, wherein comparing the updated open-loop angle with the estimated angle, a second closed-loop flag signal is output when the open-loop angle is equal to the estimated angle to complete closed-loop detection and enter closed-loop control, wherein n is a natural number greater than or equal to 1.

2. The motor closed-loop detection circuit according to claim 1, wherein the motor open-loop path comprises an open-loop angle increment generation module and an open-loop angle calculation module, wherein the open-loop angle increment generation module is configured to provide the open-loop angle increment, wherein the open-loop angle calculation module is connected to an output terminal of the open-loop angle increment generation module, and is configured to calculate an open-loop angle of a current cycle based on an open-loop angle of a previous cycle and an open-loop angle increment of the current cycle.

3. The motor closed-loop detection circuit according to claim 2, wherein the open-loop angle increment generation module comprises an increment generation unit and a multiplier, wherein the increment generation unit is configured to output the open-loop angle increment, wherein the multiplier is configured to receive an output signal of the increment generation unit, and perform a multiplication operation between the open-loop angle increment and a preset multiple when the first closed-loop flag signal is valid, to adjust the open-loop angle increment.

4. The motor closed-loop detection circuit according to claim 3, wherein the increment generation unit comprises a first adder, wherein the first adder is configured to perform an addition operation between an open-loop angle increment of the previous cycle and an angle addition increment of the current cycle, to obtain the open-loop angle increment of the current cycle.

5. The motor closed-loop detection circuit according to claim 2, wherein the open-loop angle calculation module comprises a second adder, wherein the second adder is configured to perform an addition operation between the open-loop angle of the previous cycle and the open-loop angle increment of the current cycle.

6. The motor closed-loop detection circuit according to claim 1, wherein the motor prediction path comprises a sliding mode observer, a phase-locked loop, and an angle estimation module, wherein the sliding mode observer is configured to observe motor energy based on the sampling signal, wherein the phase-locked loop is connected to an output terminal of the sliding mode observer, and is configured to extract the estimated angle increment based on the motor energy observed by the sliding mode observer and sine and cosine feedback signals of an estimated angle of the previous cycle, wherein the angle estimation module is connected to an output terminal of the phase-locked loop, and is configured to calculate an estimated angle of the current cycle based on the estimated angle of the previous cycle and an estimated angle increment of the current cycle, and generate sine and cosine feedback signals of the estimated angle.

7. The motor closed-loop detection circuit according to claim 6, wherein the angle estimation module comprises a third adder and a sine and cosine calculation unit, wherein the third adder is configured to perform an addition operation between the estimated angle of the previous cycle and the estimated angle increment of the current cycle, wherein the sine and cosine calculation unit is configured to receive an output signal of the third adder, and perform sine and cosine calculations respectively on the estimated angle output by the third adder.

8. The motor closed-loop detection circuit according to claim 1, wherein the closed-loop detection module comprises a comparison unit and a logic unit, wherein an input terminal of the comparison unit is connected to the output terminals of the motor open-loop path and the motor prediction path, wherein the comparison unit is configured to compare high-k bits of the open-loop angle increment and high-k bits of the estimated angle increment in a one-to-one correspondence, and compare high-k bits of the open-loop angle and high-k bits of the estimated angle in a one-to-one correspondence, wherein the logic unit is connected to an output terminal of the comparison unit, and is configured to output the first closed-loop flag signal when corresponding bits of the open-loop angle increment and the estimated angle increment are all equal n consecutive times within an electrical cycle range, and output the second closed-loop flag signal when corresponding bits of the open-loop angle and the estimated angle are all equal, wherein k is a natural number greater than or equal to 1.

9. The motor closed-loop detection circuit according to claim 8, wherein the logic unit comprises an AND gate and an accumulation counter.

10. The motor closed-loop detection circuit according to claim 9, wherein the AND gate is configured to output a high level when comparison results of the corresponding bits of the open-loop angle increment and the estimated angle increment are all high levels, wherein the accumulation counter is configured to accumulate the high level output by the AND gate, wherein the first closed-loop flag signal is valid when a quantity of times of consecutive accumulation of the high level output by the AND gate reaches n times.

11. The motor closed-loop detection circuit according to claim 10, wherein the AND gate is configured to output a high level when comparison results of the corresponding bits of the open-loop angle and the estimated angle are all high levels, thus the second closed-loop flag signal is valid.

12. The motor closed-loop detection circuit according to claim 1, wherein the motor closed-loop detection circuit further comprises a calculation module, and the calculation module is connected to the motor open-loop path, the motor prediction path, and the closed-loop detection module, wherein calculations in the motor open-loop path, the motor prediction path, and the closed-loop detection module are completed by reusing a calculation unit in the calculation module.

13. A motor closed-loop detection method, wherein the motor closed-loop detection method comprises at least:
separately acquiring an open-loop angle increment and an estimated angle increment, comparing the open-loop angle increment with the estimated angle increment, and generating a first closed-loop flag signal when the open-loop angle increment is equal to the estimated angle increment n consecutive times within an electrical cycle range, wherein n is a natural number greater than or equal to 1; and
adjusting the open-loop angle increment under triggering of the first closed-loop flag signal, and generating a second closed-loop flag signal when an open-loop angle is equal to an estimated angle, wherein the second closed-loop flag signal is a signal that allows a motor to switch from an open loop to a closed loop.

14. The motor closed-loop detection method according to claim 13, wherein a method for comparing the open-loop angle increment with the estimated angle increment comprises: comparing high-k bits of the open-loop angle increment with high-k bits of the estimated angle increment in a one-to-one correspondence n consecutive times within an electrical cycle range, wherein a method for comparing the open-loop angle with the estimated angle comprises: comparing high-k bits of the open-loop angle with high-k bits of the estimated angle in a one-to-one correspondence, wherein k is a natural number greater than or equal to 1.

15. The motor closed-loop detection method according to claim 13, wherein a method for adjusting the open-loop angle increment comprises:
increasing a multiple of an original open-loop angle increment, to satisfy the following relational expression:
$${Δθ}^{′} = X * Δθ ,$$
wherein Δθ′ is an updated open-loop angle increment, Δθ is the original open-loop angle increment, and X is a preset multiple greater than 1.
